(19) United States
(12) Patent Application Publication
(10) Pub. No.: US 2016/0221730 A1
(43) Pub. Date: Aug. 4, 2016

(54) HINGE CONSTRUCTION FOR GALLEY CONTAINER

(71) Applicant: ZODIAC AIRCATERING EQUIPMENT EUROPE B.V., Alkmaar (NL)

(72) Inventor: Cornelis Petrus Maria PORTEGIES, Nieuwe Niedorp (NL)

(21) Appl. No.: 15/012,902

(22) Filed: Feb. 2, 2016

(30) Foreign Application Priority Data
Feb. 2, 2015 (NL) 2014218

(51) Int. Cl. B65D 43/16; E05D 3/12

(52) U.S. Cl. CPC B65D 43/167; E05D 3/12

(57) ABSTRACT

A hinge construction for a galley container with a container body and a door includes a hinge block with a first hinge pin socket for receiving a first hinge pin to pivotally connect the hinge block to the container body and a second hinge pin socket for receiving a second hinge pin to pivotally connect the hinge block to the door. The first hinge pin socket is non-circular.

### BACKGROUND OF THE INVENTION

1. Field of the Invention

The present invention relates to a galley container or a trolley, in particular a galley cart for use in an airplane, comprising a door with a hinge construction with two parallel hinge axes. Furthermore, the invention relates to such a hinge construction for use in a galley container. The invention also relates to a method of constructing a galley container and an alignment system for a container.

2. Description of the Related Art

During short or long journeys in a vehicle, in particular an aircraft, passengers are usually provided with at least a beverage or a snack. For this purpose, food or drink products or meals are carried on board of the vehicle. For example, on an airplane, food or drink product can be carried in in galley containers that can be stored in onboard galleys. The galley container can be a galley trolley provided with wheels for transportation.

For the flight attendant, the galley container is one of the main tools when serving the passengers. The galley container typically consists of a container housing which can hold the food or drink products and a door connected to the container housing for accessing the inside. The door is typically connected to the container housing to rotate around two parallel axes, one on a side panel extrusion and another on a door extrusion. These parallel axes allow for the door to open and to be able to swing around and be held flat against a side of the container housing. The two axes are typically connected with a plurality of hinge blocks connected with hinge pins with a circular cross-section. Such hinge blocks and hinge pins allow hinge blocks to move freely independent of each other. If the hinge blocks become misaligned, the axes may not be parallel anymore causing the door to not properly close against the cabinet housing. This can lead to a door which is poorly aligned, and can result in a noisy galley container.

### BRIEF SUMMARY OF THE INVENTION

According to a first aspect of the invention, a hinge construction for a container with a container body and a door includes a hinge block with a first hinge pin socket for receiving a first hinge pin to pivotally connect the hinge block to the container body and a second hinge pin socket for receiving a second hinge pin to pivotally connect the hinge block to the door. The first hinge pin socket is non-circular.

The hinge block can be used to form two pivot axes (one through the first hinge pin socket and the second through the second hinge pin socket) for the pivotal movement of the door relative to the container body. Having a hinge block with two pivot axes can allow for large pivotal movements of the door relative to the container body, for example, allowing the door to rotate open to such a degree that it is able to sit flat against a side wall of the container body. By using a hinge block with a non-circular first hinge pin socket, the hinge block is able to receive a first hinge pin with a complementary non-circular cross-section. The non-circular complementary cross-sections ensure that the hinge block rotates with the first hinge pin and not about the first hinge pin. The rotation of the hinge block with the first hinge pin can form a more stable system that better aligns the door and the container body. Furthermore, in a system where a plurality of hinge blocks are used, each hinge block would rotate with the first hinge pin and therefore with each other, ensuring that all hinge blocks stay aligned and the two hinge axes remain parallel so that the door properly aligns with the container body.

According to an embodiment, the second hinge pin socket comprises a circular cross-section. A circular cross-section allows for full rotational movement between the door and the hinge block.

According to an embodiment, the second hinge pin socket comprises a non-circular cross-section. In such an embodiment, a second non-circular hinge pin can connect through the second hinge pin socket ensuring that the hinge block rotates with second hinge pin and not relative to it. This would bring more stability to the system and further help to prevent misalignment.

According to an embodiment, the first hinge pin comprises a D-shaped cross-section. The D-shaped cross-section could be easily formed in the hinge block and could accommodate a D-shaped hinge pin. Such a hinge pin could ensure that hinge pin and hinge block rotate together. Additionally, the D-shape could easily be accommodated and allowed for full rotation in relation to a hinge pin socket in the container body. A D-shape would also be a relatively simple shape for manufacturing a hinge pin with a non-circular cross-section.

According to an embodiment, the hinge construction further comprises a first hinge pin for inserting into the first hinge pin socket and with a non-circular cross-section corresponding to the non-circular first hinge pin socket so that the hinge block does not rotate relative to the first hinge pin; and a second hinge pin for inserting into the second hinge pin socket. The first hinge pin has a non-circular cross-section corresponding to the non-circular first hinge pin socket, which ensures that the first hinge pin and the hinge block rotate together. Rotation of the hinge block about the first hinge pin is blocked.

The invention furthermore relates to a galley container comprising the hinge connection described above.

According to an embodiment, the galley container comprises a container body, door and a hinge construction with a plurality of hinge blocks connected by a first hinge pin for inserting into the first hinge pin sockets. The first hinge pin has a non-circular cross-section corresponding to the non-circular first hinge pin sockets so that the plurality of hinge blocks rotate with the first hinge pin and do not rotate relative to the first hinge pin. Such a hinge construction in the galley container ensures that all of the hinge blocks rotate together. This ensures that the two hinge axes in the hinge construction stay parallel with respect to each other to properly align the door with the container body.

According to an embodiment, the container body comprises a container body hinge pin socket for receiving the first hinge pin for pivotally connecting the hinge block with the container body. The container body hinge pin socket is shaped to permit full rotation of the first hinge pin within the container body hinge pin socket. Such an embodiment allows for full rotation of the hinge pin relative to the container body, allowing for full pivotal movement of hinge block relative to the container body. Optionally, the container body hinge pin socket has a circular cross-section.

Past systems with parallel axes hinge constructions typically used two hinge pins with circular cross-sections. This type of hinge construction allowed for relative movement between each of the container body, the hinge blocks and the door; as well as independent movement of each of the hinge blocks. In some situations, this could result in the misalignment of hinge blocks, and therefore the misalignment of axes of rotation. Such a misalignment can lead to improper alignment of the door with the container, and in some cases further undesired effects, such as a noisy container. The hinge construction with a first hinge pin socket and a first hinge pin formed and connected so that they rotate with each other and cannot rotate relative to each other reduces the chances of misalignment and resulting undesirable effects.

According to an embodiment, the galley container further comprises a second hinge pin for inserting into the second hinge pin sockets in the plurality of hinge blocks. The second hinge pin pivotally connects the hinge block and the door.

According to an embodiment, the second hinge pin comprises a circular cross-section.

According to an embodiment, the second hinge pin comprises a non-circular cross-section. Such a second hinge pin can be shaped to fit into a second hinge pin socket in the hinge block that also has a non-circular cross-section to prevent relative rotation or movement between second hinge pin and the hinge block(s).

According to an embodiment, the door comprises a door hinge pin socket with a circular cross-section. This allows the door to pivotally connect to hinge blocks through second hinge pin, allowing for door to rotate around hinge blocks whether second hinge pin has a circular cross-section or non-circular cross section.

According to a further aspect of the invention, a method of forming a galley container with a container body, a door and a hinged connection comprises pivotally connecting the container body to a plurality of hinge blocks using a first hinge pin which fits into a first hinge pin socket in each of the plurality of hinge blocks; and pivotally connecting the door to the plurality of hinge blocks using a second hinge pin. The first hinge pin and the first hinge pin socket are shaped and fit together such that the plurality of hinge blocks rotate together with the rotation of the first hinge pin. Such a galley container construction ensures that all hinge blocks rotate with first hinge pin, keeping all in alignment and keeping the axes of rotation parallel. This ensures a proper alignment of the container body and door, resulting in fewer problems related to misalignment, such as noise.

The first hinge pin and the first hinge pin socket can ensure that the plurality of hinge blocks rotate together with the first hinge pin in a variety of ways, for example, by having complementary non-circular cross-sectional shapes (D-shape, star shape, multiple flat sides); by including a groove and/or projection; securing together by another method (pin, screw, adhesive, etc.) and/or integral formation. Other methods could also be used to form the hinge construction which rotates hinge blocks with first hinge pin, blocking relative movement between first hinge pin and hinge blocks.

According to an embodiment, the step of pivotally connecting the container body to a plurality of hinge blocks using a first hinge pin comprises pivotally connecting the container body to the plurality of hinge blocks by inserting the first hinge pin through the first hinge pin socket in each of the plurality of hinge blocks and through a container body hinge pin socket. The first hinge pin has a non-circular cross-section which corresponds to a non-circular cross-section of the first hinge pin socket.

Connecting a first hinge pin with a non-circular cross-section to a corresponding non-circular first hinge pin socket in each of the hinge blocks, ensures that the hinge blocks all rotate with the first hinge pin. This ensures that proper alignment of the hinge axes and parts of the galley container are maintained.

According to an embodiment, the step of pivotally connecting the door to the plurality of hinge blocks using a second hinge pin comprises inserting a second hinge pin into a second hinge pin socket in the hinge block and through a door hinge pin socket in the door.

According to an embodiment, the second hinge pin and the second hinge pin socket have circular cross-section.

According to an embodiment, the second hinge pin and the second hinge pin socket have non-circular cross-sections. Such an embodiment ensures that the hinge block does not rotate relative to the second hinge pin. This can lead to a more stable hinge construction, which reduces misalignment between the container body and the door.

The invention further relates to an alignment system for a container with a pivotally connected door. The system includes a container body and a hinge construction which allows for pivotal movement of the door relative to the container body. The hinge construction comprises a hinge block with a first hinge pin socket and a second hinge pin socket; a first hinge pin pivotally connecting the hinge block with the container body through the first hinge pin socket; and a second hinge pin pivotally connecting the hinge block with the door through the second hinge pin socket. The first hinge pin and the hinge block are connected such that they move together. Such a system can help to prevent misalignment between the door and the container body by ensuring that the hinge block and the first hinge pin move together and do not rotate relative to each other.

According to an embodiment, the first hinge pin and the first hinge pin socket have complementary non-circular cross-sections. This ensures the movement together of the first hinge pin and the hinge block and prevents relative rotational movement between the first hinge pin and the first hinge pin socket.

According to an embodiment, the second hinge pin and the hinge block are connected such that they move together. Optionally, the second hinge pin and the second hinge pin socket have complementary non-circular cross-sections. This can ensure that there is no relative rotational movement between the second hinge pin and the second hinge pin socket, resulting in a stable system that resists misalignment, but allows for the rotation of the door relative to the container body and hinge block.

According to an embodiment, the alignment system further comprises at least one additional hinge block. The first hinge pin extends through first hinge pin sockets in each hinge block to ensure all hinge blocks stay aligned in their rotational movements.

### BRIEF DESCRIPTION OF THE DRAWINGS

The features and advantages of the invention will be appreciated upon reference to the following drawings of a number of exemplary embodiments, in which:

FIG. 1 shows a schematic drawing of an embodiment of a galley container.

FIG. 2a shows cross-sectional view of a portion of a hinge construction for the galley container of FIG. 1 through line IIa-IIa.

FIG. 2b shows a cross-sectional view of a portion of the hinge construction of FIG. 1 through line IIb-IIb.

FIG. 2c shows a cross-sectional side view of a portion of hinge construction of FIG. 2a through line IIc-IIc.

FIG. 3 shows a perspective view of a hinge block used in the hinge construction of FIG. 2a.

FIG. 4 shows a perspective view of a second embodiment of a hinge block which can be used in a hinge construction.

### DESCRIPTION OF ILLUSTRATIVE EMBODIMENTS

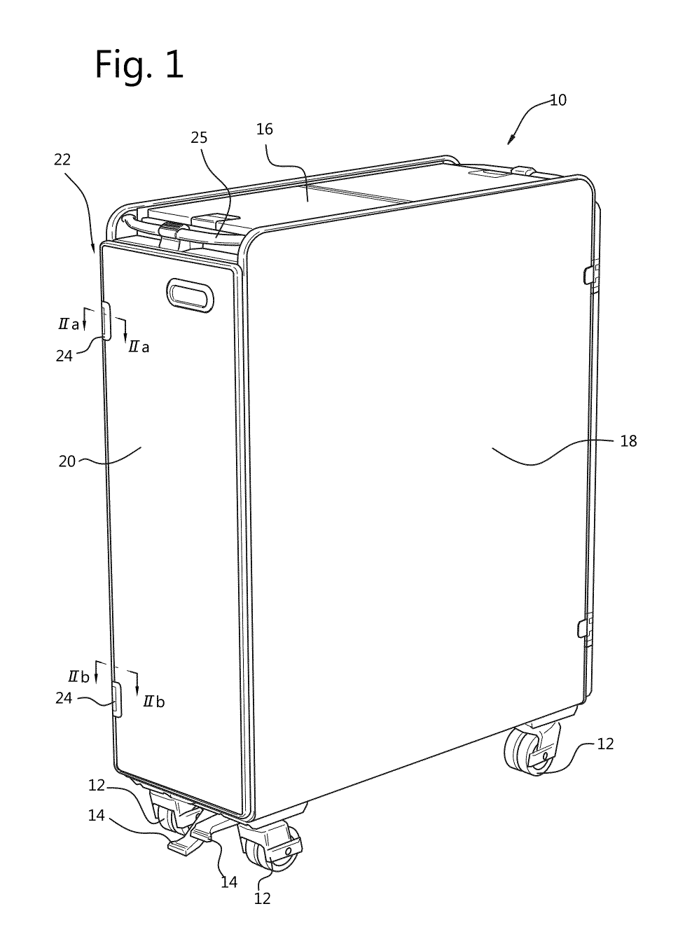

FIG. 1 shows a galley container 10 in the form of an aircraft trolley. The galley container 10 has a support base comprising wheels 12 for transport and a locking mechanism 14 to lock the wheels. The galley container 10 further includes a container body 15 with roof 16, side walls 18 and floor (not shown). An interior of the container body 15 can be accessed through door 20. Door 20 is connected to side wall 18 of the container body 15 with hinge construction 22. The galley container 10 further comprises a handle 25, which is used to push, pull and steer the galley container 10 during use.

Roof 16, side walls 18 and floor form container body 15, enclosing the interior of galley container 10 in combination with door 20. Door 20 can be opened to provide access to the interior of galley container 10. Hinge construction 22 allows for this opening, and can allow for door 20 to swing around and lay flat against side wall 18. To provide for this type of opening movement, door 20 includes hinge construction 22 with two hinge blocks 24 and parallel hinge axes.

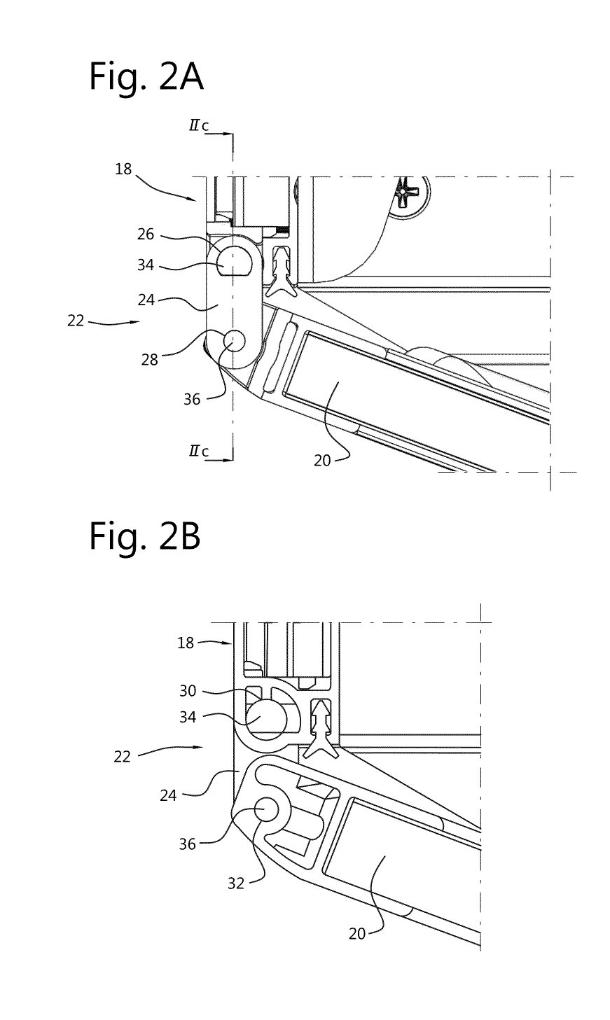

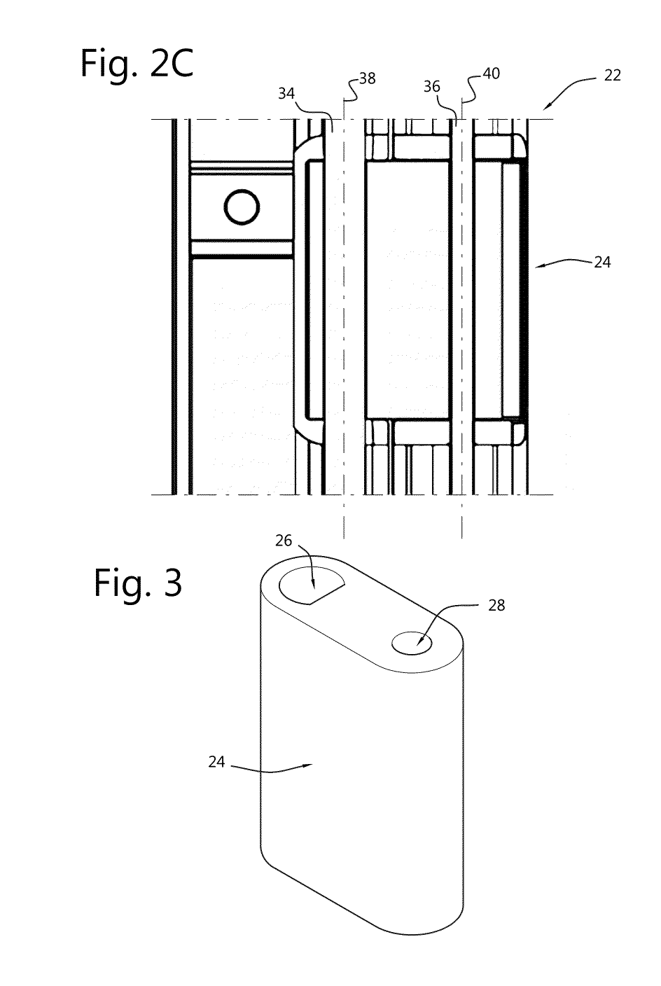

FIGS. 2a-2d show a close-up of a portion of hinge construction 22, focusing on one hinge block 24 and surrounding parts. FIG. 2a shows a cross-sectional view through hinge block 24 (line IIa-IIa in FIG. 1), FIG. 2b shows a cross-sectional view of hinge construction 22 at line IIb-IIb in FIG. 1, FIG. 2c shows a cross-sectional side view of a portion of hinge construction 22 through hinge block 24 along line IIc-IIc, and FIG. 3 shows a perspective view of hinge block 24.

Hinge construction 22 includes a plurality of hinge blocks 24 (though only one is shown in FIGS. 2a-3), though other embodiments can include just one hinge block 24. Hinge construction 22 includes first hinge block hinge pin socket 26 and second hinge block hinge pin socket 28, container body hinge pin socket 30, door hinge pin socket 32, first hinge pin 34, second hinge pin 36, first hinge axis 38 and second hinge axis 40. Also shown in FIGS. 2a-2d is container body side wall 18 and door 20 of galley trolley 10.

First hinge pin 34 extends along first axis 38 through container body hinge pin socket 30 and through first hinge block hinge pin socket 26 of each hinge block 24. Second hinge pin 36 extends through door hinge pin socket and second hinge block hinge pin socket 28 of each hinge block 24. First hinge pin 34 and second hinge pin 36 can vary in length depending on the hinge construction and galley container 10, and can be bordered on one or both ends by a stop surfaces.

First hinge pin 34 is non-circular in cross-section, and in this embodiment has a D-shaped cross-section. First hinge block hinge pin socket 26 is shaped to correspond to the cross-sectional shape of first hinge pin 34, such that hinge blocks 24 rotate with first hinge pin 34. Container body hinge pin socket 30 is shaped such that full rotation of first hinge pin 34 within socket 30 is possible, shown as circular in FIG. 2b. Second hinge pin 36 is circular in cross-section. Second hinge block hinge pin socket 28 and door hinge pin socket 32 are also circular in cross-section, such that each of hinge block 24 and door 20 can rotate relative to hinge pin 36.

Door 20 is displaceable in a direction which runs substantially parallel to the pivot axes 38, 40. By connecting container body 15 with door 20 through hinge block 24 with two hinge pins 34, 36 forming two parallel hinge axes 38, 40; door 20 is able to swing around to rest flat against side wall 18, rotating about 270 degrees. Other embodiments could allow for different rotational amounts of door.

By forming first hinge pin 34 and first hinge block hinge pin sockets 26 with non-circular complementary cross-sections, hinge blocks 24 and first hinge pin 34 rotate or move together and cannot rotate relative to each other.

Past hinge constructions on trolley containers typically used hinge blocks with two circular hinge pins connecting hinge blocks to the container body and to the door, respectively. Using two circular hinge pins allowed free rotation between the container body and hinge blocks and the door and hinge blocks at each hinge block. Thus, in some circumstances the hinge blocks can become misaligned causing the hinge axes to no longer be parallel. This can result in the door no longer connecting correctly to the container body, and can also result in a noisy trolley due to door misalignment.

Hinge construction 22 helps to overcome these issues by forming first hinge pin 34 and hinge blocks 24 with first hinge bock hinge pin sockets 26 shaped such that the first hinge pin 34 and hinge blocks 24 cannot rotate relative to each other. Thus, the rotational movement of first hinge pin 34 moves all hinge blocks 24, ensuring that hinge blocks 24 stay aligned with each other and that hinge axes 38, 40 remain parallel. This helps to prevent misalignment between door 20 and container body 15 when rotating open and/or closing, and thereby avoid associated problems, such as door 20 no longer properly closing and/or a noisy galley container 10.

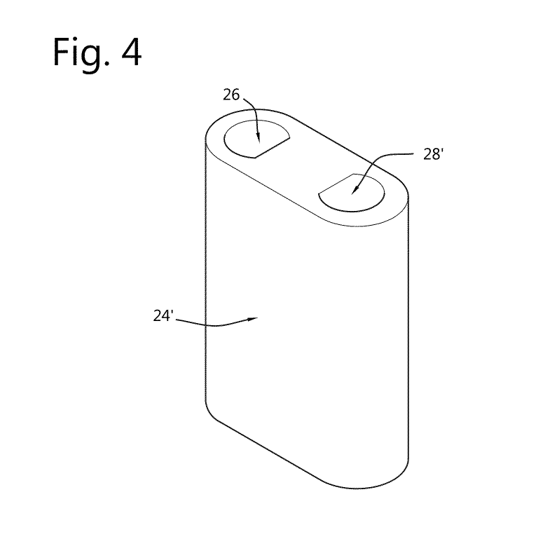

FIG. 4 shows a perspective view of a second embodiment of hinge block 24′ which can be used in hinge construction 22. Hinge block 24′ includes first hinge pin receiving socket 26 and second hinge pin receiving socket 28′. In this embodiment, each of first hinge pin socket 26 and second hinge pin socket 28′ have a non-circular cross-section. Each has a D-shaped cross-section in this embodiment, though in other embodiments each hinge pin socket could have a different non-circular cross-sectional shape or be configured in some other way which ensures there is no relative rotational movement between first hinge pin and hinge block 24′ and second hinge pin and hinge block′.

Hinge block 24′ can be used in hinge construction 22 pivotally connecting container body 18 of galley container 10 with door 20. In such a system, each of first hinge pin 24 and second hinge pin 36 would have corresponding shapes to fit through first hinge pin receiving socket 26 and second hinge pin receiving socket 28′, respectively. Each of door hinge pin receiving socket 32 and container body hinge pin receiving socket 30 would allow for full rotational movement of first hinge pin 34 and second hinge pin 36. Hinge block 24′ would not rotate relative to either first hinge pin 34 or second hinge pin 36. Second hinge pin 36 would still be able to rotate within door hinge pin receiving socket, allowing door to rotate around second hinge pin 36 and hinge pin block 24′. Thus, door would be able to rotate pivotally around second hinge axis 40, and hinge block 24′ is able to rotate around first hinge axis 38, allowing door to rotate from a position where it closes off container body 15 (FIG. 1) to a position where it sits against the side wall 18 of container body 15. Such a system would provide more stability, and ensure that hinge blocks 24′ always stay aligned despite pivotal movement of door 20.

While the first hinge pin, first hinge pin socket, second hinge pin and second hinge pin socket are shown as either circular in cross-section or D-shaped in cross-section, they can be formed and/or connected in other ways to ensure that there is no relative rotational movement between the hinge pin and the hinge block when desired. For example, other ways of shaping the cross sections can be star shaped, multiple flat sides, etc. In some embodiments, the hinge pin and/or hinge pin socket can have a groove and/or a projection to prevent relative movement. Other embodiments can include securing the two together, for example, with a screw, pin, adhesive, etc. In even further embodiments, they could be made integral.

While galley container 10 is shown with a hinge construction that includes two hinge blocks 24, other embodiments could have a different number of hinge blocks 24, for example more hinge blocks 24 or only one hinge block 24.

While the hinge construction 22 is shown as part of a galley container with wheels, hinge construction 22 could be used with another type of container, for example a container without wheels.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A hinge construction for a container with a container body and a door, the hinge construction comprising:
a hinge block with a first hinge pin socket for receiving a first hinge pin to pivotally connect the hinge block to the container body and a second hinge pin socket for receiving a second hinge pin to pivotally connect the hinge block to the door, wherein the first hinge pin socket has a non-circular cross-section.

2. The hinge construction of claim 1, wherein the second hinge pin socket has a circular cross-section.

3. The hinge construction of claim 1, wherein the second hinge pin socket has a non-circular cross-section.

4. The hinge construction of claim 1, wherein the first hinge pin comprises a D-shaped cross-section.

5. The hinge construction of claim 1, and further comprising:
a first hinge pin for inserting into the first hinge pin socket and with a non-circular cross-section corresponding to the first hinge pin socket so that the hinge block does not rotate relative to the first hinge pin; and
a second hinge pin for inserting into the second hinge pin socket.

6. A galley container comprising a container body and a door pivotally connected by the hinge construction of claim 1.

7. The galley container of claim 6, wherein the hinge construction comprises a plurality of hinge blocks, and wherein the plurality of hinge blocks are connected by a first hinge pin for inserting into the first hinge pin sockets, the first hinge pin with a non-circular cross-section corresponding to the non-circular cross-section of the first hinge pin sockets so that the plurality of hinge blocks do not rotate relative to the first hinge pin.

8. The galley container of claim 6, wherein the container body comprises a container body hinge pin socket for receiving a first hinge pin for pivotally connecting the hinge block with the container body, and wherein the container body hinge pin socket is shaped to permit full rotation of the first hinge pin within the container body hinge pin socket.

9. The galley container of claim 8, wherein the container body hinge pin socket comprises a circular cross-section.

10. The galley container of claim 6, and further comprising a second hinge pin for inserting into the second hinge pin sockets in the plurality of hinge blocks.

11. The galley container of claim 10, wherein the second hinge pin comprises a circular cross-section.

12. The galley container of claim 10, wherein the second hinge pin comprises a non-circular cross-section.

13. The galley container of claim 12, wherein the door comprises a door hinge pin socket with a circular cross-section.

14. A method of forming a container with a container body, a door and a hinged connection, the method comprising:
pivotally connecting the container body to a plurality of hinge blocks using a first hinge pin which fits into a first hinge pin socket in each of the plurality of hinge blocks, wherein the first hinge pin and the first hinge pin socket are shaped and fit together such that the plurality of hinge blocks rotate together with the rotation of the first hinge pin; and
pivotally connecting the door to the plurality of hinge blocks using a second hinge pin.

15. The method of claim 14, wherein the step of pivotally connecting the container body to a plurality of hinge blocks using a first hinge pin comprises:
pivotally connecting the container body to the plurality of hinge blocks by inserting the first hinge pin through the first hinge pin socket in each of the plurality of hinge blocks and through a container body hinge pin socket, wherein the first hinge pin has a non-circular cross-section which corresponds to a non-circular cross-section of the first hinge pin socket.

16. The method of claim 14, wherein the step of pivotally connecting the door to the plurality of hinge blocks using a second hinge pin comprises:
inserting a second hinge pin into a second hinge pin socket in each of the plurality of hinge blocks and through a door hinge pin socket in the door.

17. The method of claim 16, wherein the second hinge pin and the second hinge pin socket are circular in cross-section.

18. The method of claim 16, wherein the second hinge pin and the second hinge pin socket are non-circular in cross-section.

19. An alignment system for a container with a pivotally connected door, the system comprising:
a container body; and
a hinge construction which allows for pivotal movement of the door relative to the container body, the hinge construction comprising:
a hinge block with a first hinge pin socket and a second hinge pin socket;
a first hinge pin pivotally connecting the hinge block with the container body through the first hinge pin socket; and
a second hinge pin pivotally connecting the hinge block with the door through the second hinge pin socket;
wherein the first hinge pin and the hinge block are connected such that they move together.

20. The alignment system of claim 19, wherein the first hinge pin and the first hinge pin socket have complementary non-circular cross-sections.

21. The alignment system of claim 19, wherein the second hinge pin and the hinge block are connected such that they move together.

22. The alignment system of claim 19, wherein the second hinge pin and the second hinge pin socket have complementary non-circular cross-sections.

23. The alignment system of claim 19, and further comprising at least one additional hinge block, and wherein the first hinge pin extends through first hinge pin sockets in each hinge block to ensure all hinge blocks stay aligned in their rotational movements.
